(19) United States
(12) Patent Application Publication
(10) Pub. No.: US 2005/0027898 A1
(43) Pub. Date: Feb. 3, 2005

(54) Method of control of the different operating states of a data bus system

(76) Inventors: Helmar Kuder, Reichenbach (DE); Jochem Spohr, Ehningen (DE); Volker Stiasny, Ditzingen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/882,681

(22) Filed: Jul. 2, 2004

(30) Foreign Application Priority Data
Jul. 3, 2003 (DE) 103 29 902.5

(51) Int. Cl. G06F 13/00

(52) U.S. Cl. 710/15

(57) ABSTRACT

In a method of controlling the different operating states of a data bus system, message passing on the data bus can be switched into an inactive operating state, during which message passing on the data bus is deactivated, or into a normal operating state, in which message passing on the data bus is activated, with different communication modes being provided for control of the different message passing states on the data bus. In a first communication mode during the normal operating state of the data bus, messages containing network information are transmitted as necessary over the data bus. In another communication mode, messages containing network information in identical message format are transmitted in a repeating manner over the data bus and status information is evaluated that determines if the data bus system must remain in the normal operating state. Based on a change in status information, another communication mode assumes control of the message passing states on the data bus, and in one of the communication modes the transfer of messages containing network information in identical message format is waived in part or in whole.

This application claims the priority of German patent document 103 29 902.5, filed Jul. 3, 2003, the disclosure of which is expressly incorporated by reference herein.

The present invention provides a method for controlling the various operating states of a data bus system in which message passing may be switched either to an inactive operating state (during which message passing on the data bus is deactivated) or to a normal operating state (during which message passing is activated), with different communication modes being provided for control of the different message passing states on the data bus. In a first communication mode during the normal operating status of the data bus, messages containing network information are transferred over the data bus as needed.

Such methods of control of the different operating states of a data bus system are known from the OSEK standard in the automotive industry, which is specified in ISO 17356-5. The OSEK standard describes open systems and their interfaces for in-vehicle electronics. These include vehicle control devices and their operating system software, and data bus systems and their network management. The primary task of the OSEK network management is to keep the relevant control devices ready for bus communication, and to switch them to the inactive or idle state without bus communication. Furthermore, the OSEK network management is used for configuration monitoring in data bus systems.

It offers the following functions: Initialization of control device functions and modules, such as network interfaces, starting network communication, network-configuration monitoring, node monitoring, signaling of node or network operating states, interconnecting network specific or node specific parameters, coordinating global network operating states and diagnostics support.

In today's means of transportation (e.g., in motor vehicles), there are as many as 64 control devices, each having microprocessor, working memory and interface modules. Several control devices (for example, the engine and transmission control devices) are installed in the engine compartment, while control devices such as those used for seat control, lighting technology, and telematics are installed in the passenger compartment. All of these control devices are managed through one or more data bus systems, by which they exchange messages. If, for example, RPM is selected for display in the vehicle, the engine control device requests that information from the engine RPM sensor.

Since such data networks operate with relatively high energy consumption, certain control devices are powered down to an inactive state when not in use. The engine control device, for example, can be powered down upon engine shutdown, while the passenger compartment control devices remain in operation until the passenger compartment is locked from the outside. Alternatively, a timed delay period of several minutes after engine shutdown may be provided before some or all control devices assume the inactive state or local mode.

In the inactive state or sleep mode for example, the control device for the voltage regulator is deactivated or, only the microcomputer is deactivated and the voltage regulator remains active for a specified time period. Control devices that need to be awakened over the data bus require the CAN transceiver to be in wake-up mode.

German patent document DE 100 60 539 C1 discloses a method for controlling the different operating states in a data bus system. Each control device includes operating software, which, by means of its own information and information from other control devices, recognizes whether the control device should assume the inactive or a different operating state. Then, the operating software itself places the control device into a different operating state by activating or deactivating the related voltage regulator, or by activating or deactivating the data bus sender or receiver, or by changing the microprocessor clock pulse. In the described method, different operating states are assumed on the basis of external requests. A disadvantage exists insofar as individual requests from other control devices produce insufficient feedback for the remaining control devices regarding individual operating states.

For more reliable feedback regarding the operational states of the individual control devices, the OSEK standard describes cyclic message transmission onto the data bus containing operating data of each control device. Based on this network information, the remaining control devices recognize the operating state of a specific control device. Based on the message exchange among the control devices, the control devices can then assume the appropriate operating state.

An engine control device in idle state, for example, will switch to the normal operating mode to provide visual display of engine oil pressure. During the normal operating state of the control devices and with the use of the OSEK network management, each control device sends a cyclic message containing its network information to the data bus. Full load operation and use of all vehicle aggregates and components with high data bus message traffic frequently leads to excess bus utilization, causing message collisions that obstruct the message traffic on the data bus.

One object of the present invention is to ensure data bus reliability, and to relieve the data bus of work during an operating state with a high message-passing load.

This and other objects and advantages are achieved by the invention, in which, in a different communication mode, messages containing network information in identical message format are repeatedly transferred over the data bus. Status information indicating when the data bus system must remain in normal operating state is evaluated. In response to a change in status information, another communication mode assumes control of the message passing states on the data bus, and in one of the communication modes, the transfer of messages containing network information in identical message format is waived in part or in whole.

According to the present invention, during the normal operating state with activated bus communication, each control device injects repeating messages containing network information onto the data bus.

By evaluating this message containing network information, the remaining control devices get an overview of the current data bus operating state. When a specific status signal is evaluated, a switch to a different communication mode takes place. A communication mode without network information transfer is possible. With a change in status information, the communication mode with repeating transmission or another repeating transmission of network information can be activated. Through status information evaluation, the repeating transmission of network information onto the data bus can be activated or deactivated during initialization, normal operating state or power-down state.

With regard to resource consumption, particularly at high busload, the method of the present invention allows the application of a more advantageous communication method through the use of additional status information available in the control device.

In a preferred embodiment of the present invention, status information is transmitted to each control device over the data bus itself or by status input separate from the data bus. In the latter case, a separate connection for a status line or a fiber optic light guide can be provided, over which, for example, binary status information is transmitted to the control device. While the status information is suited to place the control device in different operating states, its primary task is to switch the software modules during a certain operating state (e.g., the normal operating state), or to determine the operating state itself.

The control device operating software selects the operating state, balancing its own current operating state, the status information, and the information requested by the other control devices. The information requested by the other control devices is transmitted in their repeating or non-repeating messages containing network information.

Repeating transmission on the data bus occurs by injection of a repeating message from the control device onto the data bus in successive time periods. Since data bus systems in means of transportation generally have asynchronous message passing (that is, messages are injected on the data bus only as necessary), a system time must be provided for the individual control devices, which recurrently sends the repeating network information containing messages from the control device to the data bus. Changes in status information, such as changing from a high to a low signal in a transmitted data bit, interrupts the repeating message passing of network information of a control device. Depending on the status information, the operating software of the control device switches the communication mode and, if appropriate, also the operating state. Thus, each control device can switch itself automatically to a different operating state and can select the method, depending on the status information.

In transfer, regular application messages describe which physical vehicle data are required for the control device message sending. Then, each receiving control device determines the necessity of switching to a different operating state.

A control device in the passenger compartment, for example, can request the RPM value from the engine control device in order to provide visual display in the vehicle. In transmitting the network information, the passenger compartment control device describes the request for the RPM value in the message placed on the data bus. The evaluating engine control device will respond to the RPM request and transmit the relevant sensor value over the data bus back to the control device in the passenger compartment. The data bus experiences great stress, for during the normal operating state all the control devices at the data bus are placing repeating network messages on it. For this purpose, during high data bus utilization, the repeating transmission of network information is replaced by single network information transmission or, if appropriate, no network information transmission. Although, the data bus system at the remaining control devices will then have less sampling of the operating state of the other control devices, this is acceptable during a high-load state at the data bus, as all control devices are working in normal operating state.

At a minimum, the different operating states of each control device include the inactive (or “sleep”) mode, an initialization state and the normal operating state. An additional power-down state might exist, in which no regular bus messages are transmitted (that is, the usual asynchronous messages at the CAN data bus are not being transmitted). The control device is powered down, depending on status information or messages on the data bus. In this power-down operating state, the relevant control device can still be awakened in an emergency.

For this purpose, a wake-up message is transferred over the data bus or status information is transmitted. Then, the control device assumes the power and reset mode, in order to immediately power up to the initialization state. As soon as the control device reaches the normal operating state, the regular data bus messages without network information are transmitted over the data bus, transmitting back and forth between the individual control devices data, such as physical vehicle data that include wheel speed, steering wheel position, lighting and driving conditions.

In a preferred embodiment of the present invention, a vehicle ignition-on signal or a data bus utilization signal is provided for status information. For example, in a motor vehicle, the voltage at clamp 15 or the voltage in the engine compartment at clamp 87 (vehicle standard) can be transmitted as an ignition-on signal. It can also be an analog signal that, in the on state, causes switching to a different method.

In power down, a communication mode can be used that works with the network's own network management messages and sends the network information onto the data bus. This ensures that the control devices at the data bus respond quickly to a change in the operating state of a single control device.

Other objects, advantages and novel features of the present invention will become apparent from the following detailed description of the invention when considered in conjunction with the accompanying drawings.

### BRIEF DESCRIPTION OF THE DRAWINGS

FIG. 1 shows the different operating states of a control device, in which the communication modes are controlled on the basis of status information according to the invention;

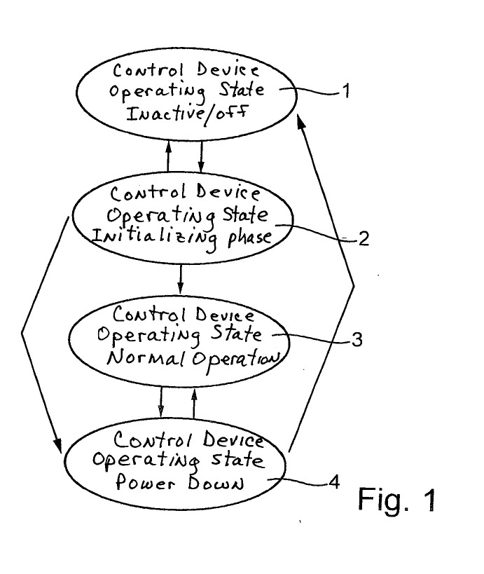

FIG. 2 is a table listing the operating states and communication modes of a control device with a network management according to the invented method; and

FIG. 3 shows different communication modes in the normal operating state of a control device, in which switching and synchronization, as well as independent parallel operation of the different methods are possible.

### DETAILED DESCRIPTION OF THE DRAWINGS

In the method according to the invention, communication modes are controlled in the different operating states of a control device. In a motor vehicle such control devices are networked over a data bus system. Each control device can be individually switched to different operating states. During a longer parking period, all control devices of a motor vehicle are in the inactive operating mode 1, and the control device microprocessor, voltage regulator, and sender and receiver for the data bus signals are shut down. The inactive operating state includes the so-called standby mode, in which the voltage regulator remains activated to enable the microprocessor to be powered up without a transient state of the voltage regulator. This standby mode is usually activated when the motor vehicle is parked for a relatively short period of time.

When the motor vehicle door is unlocked with an electronic key, a central control unit sends a so-called wake-up message over the data bus, causing the other connected control devices to switch to the control device initializing state 2, then waking up the microprocessor and finally the sending/receiving unit for the data bus.

During this so-called control device initializing state 2, the above-described control device hardware is powered up and all the control device software data necessary for program initialization are loaded into the working memory. After the individual software variables are allocated, the control device is ready. At the end of the control device initializing state 2, hardware and software programs of the control device concerned are fully operational and the data bus is switched to its normal operating state 3.

During the normal operating state 3 of the data bus, the control devices regularly exchange messages over the data bus. This happens either synchronously (in the time slots assigned to each control device) or asynchronously (messages are injected onto the data bus by each control device when message transfer is required). This regular message passing is necessary, because the control devices in the passenger compartment need information from the engine control devices and vice versa. Particularly, sensors and actuators in the engine compartment are to be controlled or activated by operating elements inside the passenger compartment, by which a message is transmitted over the data bus from the passenger compartment to the engine compartment and passed on to the actuator by the relevant engine control device. The low beam headlight, for example, can be activated inside the engine compartment—the driver sends a request via control switch inside the passenger compartment.

When specific control devices are no longer required for the correct function in the motor vehicle, the data bus is shifted to the data bus inactive operating state (1).

When the engine is shut down and certain control devices in the engine compartment can be powered down while control devices in the passenger compartment are still in data bus normal operating state 3, the entire data bus system can save energy and relieve the vehicle battery. In the control device power-down state 4, the control device is gradually and properly powered down. During the whole control device power-down state 4, the control device can be quickly awakened by wake-up requests from other control devices. At the end of the control device power-down state 4, the data bus is in the data bus inactive operating state 1. Subsequent to vehicle ignition shutdown, certain control devices are still working in the control device normal operating state 3, while other control devices are in control device inactive operating state 1. Even during vehicle driving, different control devices can be in one of the control device operating states 1 through 4.

In the control device operating states 2 and 3, information about the actual control device operating state 2 to 3 of the relevant control device is passed on to the data bus. This way, the other control devices can determine the control device operating state 1 through 4 of the relevant control device. With these so-called network information communication modes of a control device, the control device transmits a message onto the data bus describing its own operating state and the required information from other control devices, as necessary. The different control device operating states 2 and 3 allow different communication modes. For example, repeating message passing can take place, so that each control device can transmit operating status messages through a repeating synchronized cycle.

It is also possible that the operating state of a control device is separately injected onto the data bus upon request from another control device, resulting in a significantly lower data bus load. Finally, transfer of messages containing control device network information can be deactivated, so that other control devices can infer the control device operating state (e.g., inactive 1) from the missing control device response.

The method of control of the different operating states of a data bus system can support network management software that provides messages containing control device network information. Besides the actual message, each message includes unambiguous identification that is necessary for the control of the data bus behavior. For identification, the control devices in logical succession can, for example, be numbered in ascending order. Message passing can be arranged in such manner that the message is sent from a first data bus control device to the data bus control device that is next in logical order, which then sends the information to its logical successor. This kind of message passing is, for example, necessary in initializing the data bus and the related control devices in a loop network. After transition to the data bus normal operating state 3, each control device sends an initialization message over the data bus and receives network messages from other participants.

The communication among the control devices that is necessary for the initialization stresses the data bus, which in the worst case, may lead to impairment of the regular communication among the control devices. Further difficulties may occur in systems that send clocked requests for the received message, if specific network management messages cannot be read during the initializing phase and the participating control devices at the data bus, for example, cannot build a logical loop.

The present invention provides an improved method of data bus system communication management. It improves the communication behavior itself with respect to information concerning network management. Information about control device operating states in form of repeatedly sent messages over the data bus is exchanged, and in other operating states this repeating information exchange is deactivated. The method requires a minimum of one method of control of data bus data and standby operation at each control device in the network, while further alternate management methods can be applied depending on the operating state of the individual control devices.

In a communication mode controlled by the method according to the invention, control devices are activated by status information. This status information can use the data bus or a separate data line. In the first case, data transfer over the data bus is required. In another communication mode, status information is used in the switching of the different operating states. Status information can be transmitted to the control device through a separate line or it can be received over the data bus.

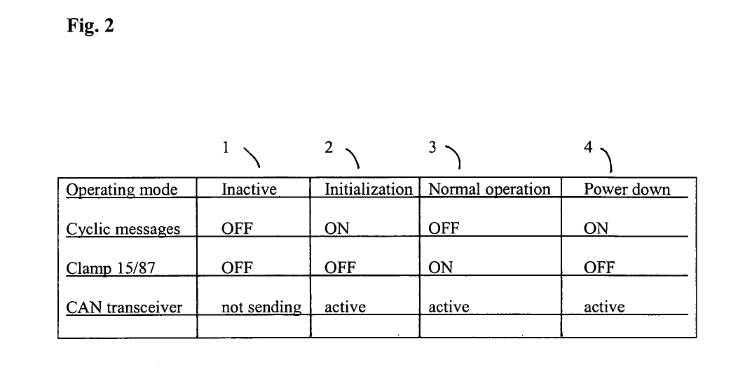

FIG. 2 shows a method of control of the different operating states of a data bus system depending on the different control device operating states 1 through 4 in a vehicle data bus system according to the present invention. Each control device can be switched to the four known control device operating states 1 through 4.

In the present communication mode, the OSEK network management in the control device inactive operating state 1 and in the control device normal operating state 3 is deactivated, while it is activated in the control device initialization phase 2 and the data bus power-down phase 4.

In the presented method, the ignition-on signal in the engine compartment at clamp 15 or clamp 87 is sent as a status signal over a separate line or over the data bus to each control device. The method controls the communication mode in such manner that during the control device inactive operating state 1, the OSEK network management remains disconnected.

The table in FIG. 2 shows how, with the method according to the present invention, the sender/receiver (e.g., a CAN transceiver) is controlled during the different control device operating states. During the control device inactive operating state 1, each control device can be awakened. This can be effected over the data bus. However, in order to conserve energy, sender and receiver are deactivated during this control device operating state 1. A wake-up signal over the data bus only makes known the change in the voltage level. Then, the concerned control device is switched to the control device initialization state 2. During the control device operating states 2 through 4, the CAN transceiver is switched to active so that the sender and the receiver are fully operational and can send or receive messages over the data bus.

As long as the ignition-on status information is available at clamp 15 or clamp 87, all the control devices at the data bus, particularly the control devices at the drive train, are needed. Upon loss of this status information, the OSEK network management is initialized, and switching to the relevant communication method takes place.

This supports the data bus and the control devices in power down, puts the data bus in an idle state, and provides a wake-up mode for the data bus.

When the control device is awakened by a network management message from a control device, the OSEK network management is initialized and assumes control of the different operating states of the data bus system, until the data bus returns to the idle state or ignition-on signal status information is received. If the reason for the control device wake-up is not a network management message (i.e., not a message containing network information), the message is checked for ignition-on signal status information and the control device communication mode is selected accordingly. In a different communication mode, a message can be sent from the electronic ignition lock over the data bus. This message contains the ignition-on status information, which causes the deactivation of the repeating message passing of the control devices with their network information.

If a control device is going through a power-on reset (i.e., the control device is powered up), initializing of all software modules takes place, to include the standard OSEK network management and the hardware. Prior to the first network management message being sent, a decision must be made, namely which communication mode should be used at the control device.

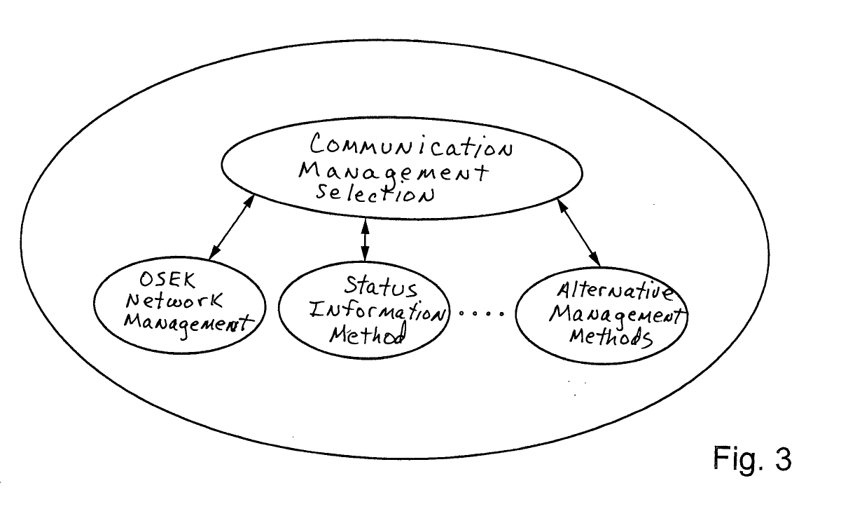

FIG. 3 shows the communication mode operations for a control device in the normal operating state. The data bus with the control devices can, for example, be operated in the standard OSEK network management method, wherein individual messages containing network information can be received by other control devices over the data bus.

The data bus is then operated with the repeating network management messages, which are continuously sent out in specific recurring time intervals. Finally, the method according to the present invention can be applied with evaluation of status information, in which the repeating use of network management messages by the individual control devices during the normal operating state, particularly during high utilization of the data bus, is deactivated. Alternate management methods may also be applied.

If a control device fails, and cannot participate in bus communication, this device is detected by the other control devices due to its missing messages. Mixed operation among the different communication modes in data bus normal operation state 3 may also be provided. During high bus load, for example, the repeating network management message passing on the data bus can be discontinued, but performs during low-load times.

With the method according to the present invention, each control device includes communication management software that switches among the different communication modes, depending on the control device operating states 2 and 3, and status information. In this manner, data bus system utilization can be optimized. The advantage of the new method lies in its efficiency and in conservation of resources. Deactivating the repeating network management messages leads to reduced data bus utilization. The OSEK network management is activated during data bus power up and power down.

So far, there has only been one method in the OSEK network management in automotive engineering that allows the data bus to be synchronously switched in an idle state.

The method according to the present invention provides the possibility for several communication modes on the data bus. A communication mode evaluates status information (e.g., ECU-ON/ECU-OFF, NM method status). Another example for status information is the ignition signal in a motor vehicle at clamp 15 or clamp 87.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A method for controlling different operating states of a data bus system, wherein message passing on the data bus can be switched into an inactive operating state in which message passing on the data bus is deactivated, and a normal operating state in which message passing on the data bus is activated, wherein different communication modes are provided for control of the different operating states on the data bus, with messages containing network information being transferred over the data bus, as necessary, in a first communication mode during the normal operating state of the data bus; said method comprising:
in another communication mode, transmitting messages containing network information in identical message format, in repeating manner over the data bus;
evaluating a status information which defines whether the data bus system must remain in the normal operating state;
based on a change in the status information, said another communication mode assumes control of the message passing states on the data bus; and
in one of the communication modes, the transfer of messages containing network information in identical message format is waived at least in part.

2. The method according to claim 1, wherein the status information is transmitted to each control device over the data bus or by status input separate from the data bus.

3. The method according to claim 1, wherein:
in addition to the inactive and normal operating states, a further state is provided for power up or power down;
in the further operating state, transfer of messages containing network information in identical message format is not waived.

4. The method according to claim 1, wherein said method is applied in a network management of a single data bus.

5. The method according to claim 1, wherein the messages containing network information in identical message format contain network information describing a present communication state of the data bus, relative to the control device.

6. The method according to claim 1, wherein depending on the status information, the data bus system is powered down to the inactive operating state, for which a data bus power-down operating state is provided during which no regular bus messages are transmitted.

7. The method according to claim 2, wherein status information is provided to the control devices, indicating if the data bus must to be in the normal operating state.
